(19) United States
(12) Patent Application Publication
(10) Pub. No.: US 2026/0054109 A1
(43) Pub. Date: Feb. 26, 2026

(54) Fire and/or Smoke Curtain

(71) Applicant: Coopers Fire Limited, Waterlooville (GB)

(72) Inventor: Allan Bruce McKay, Waterlooville (GB)

(21) Appl. No.: 19/304,695

(22) Filed: Aug. 20, 2025

(30) Foreign Application Priority Data
Aug. 20, 2024 (EP) 24195301.7

(51) Int. Cl. A62C 2/10; A62C 2/24

(52) U.S. Cl. CPC A62C 2/10; A62C 2/242

(57) ABSTRACT

A fire and/or smoke curtain includes a roller, a fire and smoke curtain, and a retaining mechanism. The mechanism comprising an end plate for holding an end of the roller, a brake disc attached to the end of the roller. A connector attaches to the brake disc, the connector having a hook or ring element attached to a release mechanism comprising a lock element secured to the end plate at a proximal end, having a stop at its distal end and provided with a hook element onto which the hook or ring element of the connector is fitted, sliding lock element adapted to slide along a fixed plate, from a secure position in which the sliding lock is adapted to hold the hook or ring, and a release position, in which the hook or ring is released, releasing the brake to allow rotation of the roller and deploy the curtain.

### CROSS REFERENCE TO RELATED APPLICATION

This patent application claims the benefit and priority of European Patent Application No. 24195301.7 entitled “Fire and/or Smoke Curtain” filed with the European Patent Office on Aug. 20, 2024, the disclosure of which is incorporated by reference herein in its entirety as part of the present application.

### INTRODUCTION

The present invention relates to a fire and/or smoke curtain and a release mechanism therefor, particularly though not exclusively for a non-powered fire and/or smoke curtain.

### BACKGROUND TO THE INVENTION

Fire and/or smoke curtains have been designed to stop or at least slow the progress of smoke and fire around a building or area, and to create safe routes for the evacuation of persons in the building. Smoke curtains generally extend a short distance from the ceiling and are intended to direct the flow of smoke around the building, and preferably towards a smoke exit. Fire or smoke and fire curtains typically extend from the ceiling of a building to the floor and are intended to prevent the passage of smoke into certain areas to allow for the escape of persons from the building, and also to slow or stop the spread of fire.

Many fire and/or smoke curtain assemblies require a power supply, either to activate the curtain, or more commonly to retain the curtain in the retracted or wound position, and to re-wind after use. In event of a fire alarm or power outage, for example as a result of a fire, the curtain is automatically deployed.

Alternative mechanisms for deployment of a fire and/or smoke curtain exist, often including fusible links. However, such mechanisms currently used can be unreliable. Thus, there is a need for a fire and/or smoke curtain assembly that is cost efficient to run and simple to fit. Such curtains may be particularly suitable for car parks where they can be installed between bays, warehouses and other buildings, or on the outside of buildings as protection from wildfires and the like.

The object of the invention is to provide a fire and/or smoke curtain that can be used without the requirement for a power source connection.

### SUMMARY OF THE INVENTION

According to the invention there is provided a fire and/or smoke curtain assembly comprising:—
a roller having a central shaft;
a fire and smoke curtain for rolling onto and deployment from the roller; and
a retaining mechanism for retaining the curtain rolled onto the roller and for allowing deployment of the event of a fire, the mechanism comprising:
   an end plate through which the central shaft of the roller extends;
   a brake disc attached to the shaft of the roller and acting against the end plate to slow rotation of the roller during deployment;
   a connector attached to the brake disc, the connector having a first linking element;
   a release mechanism comprising
      a lock element secured to the end plate at a proximal end;
      a slide element, adapted to slide along the lock element, having a stop at its distal end and provided with a second linking element onto which the first linking element of the connector is fitted;
      a spring on the slide element acting between the stop and the lock element, to retain the slide element in a retained position in the absence of any other force;
      a lever plate attached to the end plate by one end, and adjacent to the slide element,
      a pull element for rotating the lever plate about its attachment point,
the arrangement being such that normally the roller shaft is prevented from turning by the connector being held by the slide element; on pulling of the pull element, the lever plate rotates, moving the slide element relative to the lock element against the spring, dislodging the first linking element off the second linking element on the slide element, releasing the brake disc and allowing the roller to rotate to deploy the curtain.

Preferably, the pull is a chain.

Conveniently, the connector may incorporate a thermal fuse link element, such that in the event of a fire, the heat therefrom will break the link releasing the curtain for deployment.

Advantageously, the slide element may comprise a front section, a back section, a central top section and a central lower section, secured together and surrounding the lock element, for sliding thereon.

The lever plate may comprise a front lever plate attached to a back lever plate.

Preferably, in a normal position, the lever plate abuts the slide element.

Typically, the first linking element is a hook or ring element. Typically, the second linking element is a hook.

The brake disc may be provided with a brake lining between the brake disc and end plate for increasing the friction thereagainst. The brake disc and brake lining will slow the speed of descent of the curtain on deployment, while allowing deployment. Alternatively, the brake disc may include other means for slowing descent, such as a centrifugal clutch.

Preferably the lock element comprises front and back elements, surrounding the slide element. Advantageously, the front element may have a cut out at a position to expose the hook on the slide element when in a retained position.

The brake disc may be secured to the roller shaft via a brake hub, typically using grub screws.

Preferably, the connector comprises a bracket that it attached to the brake disc, to which link is attached, incorporating a thermal fuse link, and the hook or ring.

Advantageously a manual means may additional be provided for re-winding the curtain. The manual means for rolling the curtain onto roller may be a manual crank. Typically, a handle for the crank may be removable, for storage away from the arrangement, for safely and security.

In some arrangements a side guide may be provided at one or both sides of the curtain, for holding the curtain on deployment. The provision of a side guide will be dependent on the arrangement of the building into which the fire and smoke curtain is placed. In some situations, no side guides will be provided.

Preferably, the roller is stored in a headbox mounted on a ceiling in the building. The headbox may be open at its base to allow for deployment of the curtain.

The fire and smoke curtain may be a standard fire and smoke curtain, such as for example EFP2/1000S, EFP/A1 or EFP/VEF materials from Coopers Fire Limited, of Waterlooville, Hampshire, UK, which comprises a woven metal material. Such materials are generally considered fireproof as they prevent a fire from passing from one side of the curtain to another for a certain period of time or until a certain temperature has been reached. The fire and smoke curtain may additionally comprise a material that is considered to be both insulating as well as fireproof. Such materials are also available from Coopers Fire Limited as set out above. Such materials prevent both the passage of fire and the passage of heat, again for a period of time or until a certain temperature has been reached on the fire side of the curtain. Alternative fire proof or fire resistant materials may also be used, including layered materials.

Traditional fire and smoke curtains are provided with a bottom bar to weight the curtain for deployment and one deployed to maintain its position. Such a bottom bar is made of metal and is designed to lie flat on the floor on deployment. Such bottom bars can also provide a closure from a headbox where provided. The fire and/or smoke curtain assembly may further include a bottom bar attached to the bottom of the curtain. Alternatively, the curtain may be provided with weighted pockets. Preferably such weighted pockets are provided spaced along the bottom of the curtain. A bottom end of the curtain may be folded back up the curtain and sewn to provide a pocket. This may be divided into many pockets by vertical stitching. Weights may be provided in all or some of the pockets. The weights will typically be of metal as these are dense and fire resistant to a high temperature. The weights may be provided a steel or lead shot. Alternatively, the weights may be provided as steel or lead discs, or be curtain weights

### DETAILED DESCRIPTION OF THE INVENTION

To help understanding of the invention, a specific embodiment thereof will now be described by way of example and with reference to the accompanying drawings, in which:—

FIG. 1 is a perspective view of a fire and/or smoke curtain deployed;

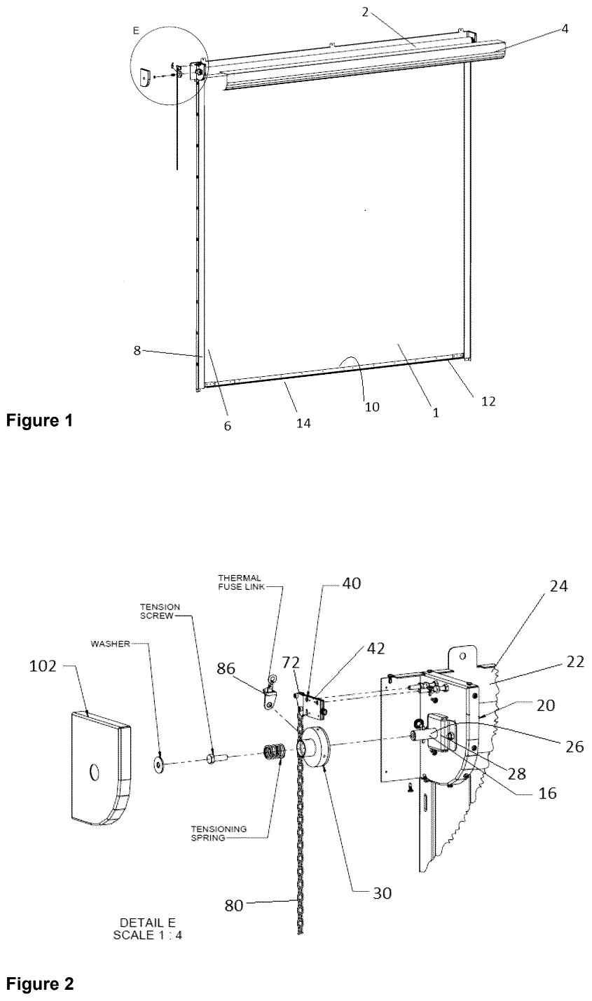

FIG. 2 is a perspective view of the release mechanism according to the invention for the fire and/or smoke curtain arrangement of FIG. 1;

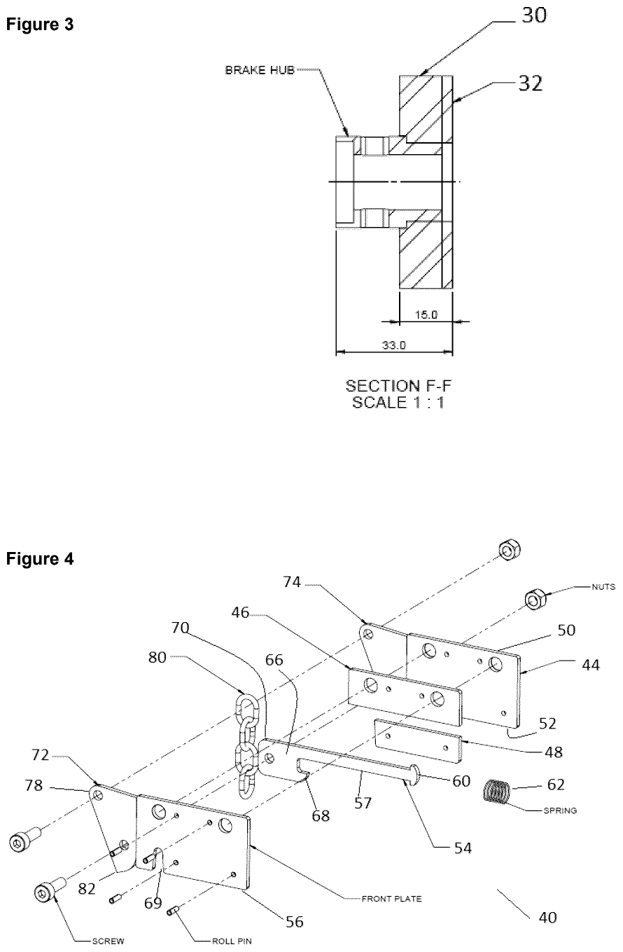

FIG. 3 is a sectional view through a brake disc of the release mechanism;

FIG. 4 is an expanded view of the releasing mechanism;

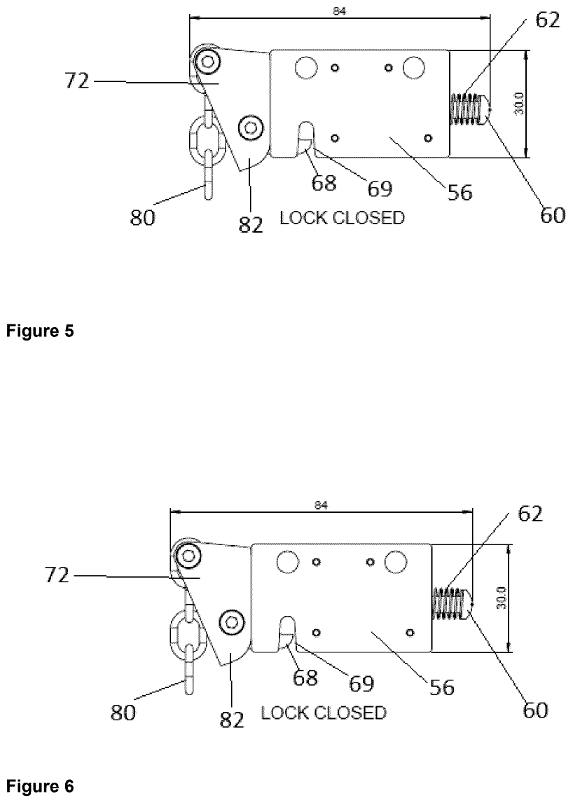

FIG. 5 is a view of the releasing mechanism closed;

FIG. 6 is a view of the releasing mechanism opened; and

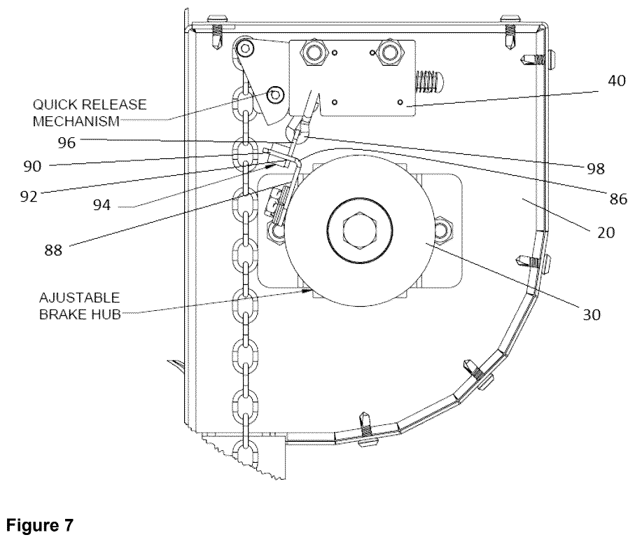

FIG. 7 is a view of the release mechanism.

Referring to the Figures, FIG. 1 shows a fire and/or smoke curtain 1 deployed from a roller 2. The roller 2 is provided within a headbox 4 . While such a headbox 4 is usually provided, this is not essential and may not be provided at all. Nevertheless, a headbox 4 can provide protection to the curtain 1 and roller 2, for example from dust and dirt.

Sides 6 of the curtain 1 are held within side guides 8, although the presence of side guides 8 is optional and they will not always be provided.

The bottom end 10 of the curtain is provided with a bottom bar 12. This sits on the floor 14 or ground on deployment maintaining the position of the curtain 1. The bottom bar 12 can also provide a closure to the headbox 4. While the curtain 1 will be weighted to ensure descent and holding the bottom of the curtain against the floor or ground 14 on deployment, a bottom bar 12 will not always be provided. For example, weighted pockets (not shown) may be provided at the bottom end 10 of the curtain 1. These have a similar effect to the bottom bar 12.

The central shaft 16 of the roller 2 extends through an end plate 20, which is secured to a solid surface 22 in a building, for example a wall 24 or ceiling. The end plate 20 may form a side end of the headbox 4 (if provided) or may be in addition to the headbox (if provided). Alternatively, the end plate 20, may be stand alone. The central shaft 16 passes through an aperture 26 in the end plate 20 allowing the shaft to rotate. The apertures 26 may be reinforced 28.

Secured to the central shaft 16 is a brake disc 30 which rotates with the shaft 16 as the curtain 1 is wound onto and unwound from the roller 2. The brake disc 30 is provided with a brake lining 32 which acts against the end plate 20 to slow the rotation of the shaft 16 and thus the descent of the curtain 1.

To hold the curtain 1 rolled onto the roller 2 and in the retracted position until a fire is detected, and to enable release of the curtain 1 in the event of a fire, a lock and release mechanism 40 is provided.

The lock and release mechanism 40 comprises a fixed element 42 comprising a back plate 44, affixed to the end plate 20. A top guide 46 and bottom guide 48 are fixed to the back plate 44, adjacent to the top 50 and bottom 52 of the back plate 44.

Between these guides 46, 48, sliding lock 54 is provided. This is not attached to the back plate 44.

A front plate 56 is provide over the top guide 46, bottom guide 48 and sliding lock 54. It is the combination of the back plate 44, top guide 46, bottom guide 48 and front plate 56, maintain the position of the sliding lock 54.

The sliding lock 54 comprises an elongate section 57 with sits between the top guide 46 and bottom guide 48. One end of the sliding lock 54 is provided with an enlarged portion 60, providing a stop for a spring 62, fitted over the elongate section 57. The spring 62 also acts against the top guide 46 and bottom guide 48. The other end of the sliding lock 54 comprises a broader section 66, with a hook element 68 extending below the elongate section 57.

The bottom guide 48 is shorter than the top guide 46 to accommodate the broader section 66 and hook element 68. The spring 62 holds the sliding lock 54 with the elongate section 57 between the top guide 46 and bottom guide 48, with the hook element 68 abutting, or adjacent the bottom guide 58. The front plate 56 is provide with a notch 69 through this the hook element 68 can be seen and contacted, when the sliding lock 54 is in its standard position, as described.

The end 70 of the broader section 66 is held between a front lever plate 72 and back lever plate 74, which in turn abut the front plate 56 and back plate 44, with the end 70 of the sliding lock 54 being secured to the lever plates 72, 74.

Attached to another end 78 of the front lever plate 72 and back lever plate 74 is a chain 80. The arrangement is such that pulling of the chain rotates the front and back lever plates 72, 74, a bottom end 82 of the lever plates 72, 74 cams against the front plate 56 and back plate 44, pulling the sliding lock 54 against the spring 62.

Attached to the brake disc 30 is provided an L-plate 86, with one arm 88 fixedly secured to the disc brake 30 and the other arm 90, extending therefrom. This arm 90 is provided with an aperture 92, through which is provided a thermal fuse link 94. One end of the link 94 is thickened to prevent it passing through the aperture 92. The other end 96 is provided as a hook 98, sized to link to the hook element 68 on the sliding lock 54. This holds the brake 30, 32 and prevents the brake 30, 32 and roller 2 from rotating.

A cover plate 102 is provided, covering the release mechanism, and protecting the same from environmental damage, including dust and debris in the air.

In the event of a fire or indeed for testing, pulling of the chain 80, slides the sliding lock 54 against the action of the spring 62, along the bottom 48 and top 46 guides, moving the hook element 68 away from the notch 69 in the front plate, and thereby displacing the hook 68 and releasing the disc brake 30 and allowing rotation of the roller 2, thereby causing the curtain 1 to descend.

Alternatively, in the result of a fire, the heat generated thereby will case the thermal fuse link 94 to break, again, releasing the disc brake 30 and allowing rotation of the roller 2, thereby causing the curtain 1 to descend.

In order to raise the curtain 1 again after deployment, a crank handle (not shown) may be provided.

Thus, this arrangement provides from a simple fire and/or smoke curtain release mechanism that maintains the curtain in a retracted position without the constant application of power. Such an arrangement is suitable for use in many situations, for example car parks, where minimum maintenance is needed. Alternatively, the arrangement is particularly suitable for the use on the outside of residential buildings where wildfires are a possibility.

1. A fire and/or smoke curtain assembly comprising:—
a roller;
a fire and smoke curtain for rolling onto and deployment from the roller; and
a retaining mechanism for retaining the curtain rolled onto the roller and for allowing deployment of the event of a fire, the mechanism comprising:
an end plate through which a central shaft of the roller extends;
a brake disc attached to the shaft of the roller and acting against the end plate;
a connector attached to the brake disc, the connector having a first linking element;
a release mechanism comprising
a lock element secured to the end plate at a proximal end;
a slide element, adapted to slide along the lock element, having a stop at its distal end and provided with a second linking element onto which the first linking element of the connector is fitted;
a spring on the slide element acting between the stop and the lock element, to retain the slide element in a retained position in the absence of any other force;
a lever plate attached to the end plate by one end, and adjacent to the slide element,
a pull element for rotating the lever plate about its attachment point,
the arrangement being such that normally the roller shaft is prevented from turning by the connector being held by the slide element; on pulling of the pull element, the lever plate rotates, moving the slide element relative to the lock element against the spring, dislodging the first linking element off the second lining element on the slide element, releasing the brake disc and allowing the roller to rotate to deploy the curtain.

2. A fire and/or smoke curtain assembly according to claim 1, wherein the pull is a chain.

3. A fire and/or smoke curtain assembly according to claim 1, wherein the connector incorporates a thermal fuse link.

4. A fire and/or smoke curtain assembly according to claim 1, wherein the slide element comprises a front section, a back section, a central top section and a central lower section, secured together and surrounding the lock element, the lock element sliding thereon.

5. A fire and/or smoke curtain assembly according to claim 1, wherein the lever plate comprises a front lever plate attached to a back lever plate.

6. A fire and/or smoke curtain assembly according to claim 1, wherein in a normal position, the lever plate abuts the slide element.

7. A fire and/or smoke curtain assembly according to claim 1, wherein the brake disc is provided with a brake lining between the brake disc and end plate for increasing the friction thereagainst.

8. A fire and/or smoke curtain assembly according to claim 1, wherein the brake disc a centrifugal clutch for slowing rotation.

9. A fire and/or smoke curtain assembly according to claim 1, wherein the brake disc is secured to the roller shaft via a brake hub, typically using grub screws.

10. A fire and/or smoke curtain assembly according to claim 1, wherein the connector comprises a bracket that it attached to the brake disc, to which link is attached, incorporating a thermal fuse link, and the first linking element.

11. A fire and/or smoke curtain assembly according to claim 1, wherein a manual means is provided for re-winding the curtain.

12. A fire and/or smoke curtain assembly according to claim 1, further comprising a side guide at one or both sides of the curtain, for holding the curtain on deployment.

13. A fire and/or smoke curtain assembly according to claim 1, wherein the roller is stored in a headbox mounted on a ceiling in the building.

14. A fire and/or smoke curtain assembly according to claim 1, further comprising a bottom bar to weight the curtain for deployment and one deployed to maintain its position.

15. A fire and/or smoke curtain assembly according to claim 1, wherein the curtain is provided with weighted pockets.
